(19) United States
(12) Patent Application Publication
(10) Pub. No.: US 2008/0011409 A1
(43) Pub. Date: Jan. 17, 2008

(54) Method for Manufacturing Tire and Apparatus Used Therefor

(76) Inventor: Yuichiro Ogawa, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 11/597,708

(22) PCT Filed: Apr. 28, 2005
(86) PCT No.: PCT/JP05/08162

§ 371 Date: Aug. 10, 2007

(30) Foreign Application Priority Data
Jun. 8, 2004 (JP) 2004-169382

(51) Int. Cl. B29D 30/16

(52) U.S. Cl. 156/117; 156/397

(57) ABSTRACT

There are provided a method for manufacturing a tire which can suppress residual air and occurrences of bares, flow cracks and the like, which cause a reduction of the durability of a product tire, by flattening a stepped part formed at an overlapping portion of a tire component member under pressure to optimize a cross sectional shape of the overlapping portion, and an apparatus used for this method. The apparatus (1) comprises a building platform (2), a rubber strip extruder (3), and a pressing roller (4). A specified tire component member is formed by spirally winding a ribbon-shaped rubber strip 5 extruded by the rubber strip extruder (3) while making an overlapping portion to apply it on the building platform (2). A stepped part (8) of the overlapping portion (7) exposed to the outer surface of the tire component member is flattened under pressure by the pressing roller (4) which is arranged to face the building platform with a specified slip angle α with reference to the extending direction of the applied rubber strip (5) and which is heated up to a plasticizing temperature region to smoothen the outer surface of the tire.

### TECHNICAL FIELD

The present invention relates to a method for manufacturing a tire including a step of forming a specified tire component member by spirally winding a ribbon-shaped rubber strip while making an overlapping portion to apply it directly or indirectly on a building platform such as a rigid core or a building drum, and an apparatus used for this method. Specifically, the present invention relates to preventing the rubber strip from falling off from the sidewall, which reduces the durability of a product tire.

### RELATED ART

In recent years, in order to reduce process manpower and operation time necessary for the tire-building process as well as to realize a smaller manufacturing unit by eliminating the use of an apparatuses for manufacturing tire component members, a method for manufacturing a specified product tire has been proposed, in which, instead of separately preparing each of tire component members such as an inner liner, a bead filler, a side rubber and a tread rubber, a ribbon-shaped rubber strip is spirally winded and applied on a building platform such as a rigid core or a building drum while making an overlapping portion to build a specified green tire and the green tire is vulcanized to obtain the specified product tire (see Japanese Patent Application Laid-Open No. 2000-289122, for example).

In this method, a stepped part, the height of which corresponds to that of the rubber strip, occurs at the overlapping portion exposed to the outer surface of the tire component member and this stepped part cannot be sufficiently molded especially at the sidewall portion during the vulcanization, so that bares and flow cracks may be present in the product tire, which cause problems of deteriorating the durability of the product tire.

Moreover, air enclosed between the stepped part of the overlapping portion and a tire-vulcanizing mold is also likely to remain in the tire component member as it is incorporated by a rubber flow during the vulcanization, with the result that the durability of the product tire may be deteriorated as stress concentrates at the air-remaining portion in using the product tire.

In order to suppress the residual air and occurrences of the bares, the flow cracks and the like in the product tire by eliminating the stepped part, WO 02/078939 describes a method of smoothing the outer surface of the tire component member by flattening the stepped part formed at the overlapping portion under pressure by the roller or the like. However, the rubber strip has low plasticity at ambient temperature, so that, in order to flatten the step sufficiently under pressure, pressing force applied to the roller has to be excessive or pressing time by the roller has to be long. Therefore, it is difficult to improve production efficiency and, moreover, it is possible that the desired durability is not acquired as the shape of the rubber returns back to the original shape after pressing due to the elasticity of the rubber.

### DISCLOSURE OF THE INVENTION

Therefore, the object of the present invention is to provide a tire-manufacturing method which can suppress residual air and occurrences of bares, flow cracks and the like, which cause a reduction of the durability of a product tire, by flattening a stepped part formed at an overlapping portion of a tire component member under pressure to optimize a cross sectional shape of the overlapping portion, and an apparatus used for this method.

In order to achieve the above-mentioned object, the tire-manufacturing method according to the invention comprises a step of forming a specified tire component member by spirally winding a ribbon-shaped rubber strip while making an overlapping portion to apply it directly or indirectly on a building platform such as a rigid core or a building drum, wherein a stepped part of the said overlapping portion exposed to the outer surface of the said tire component member is flattened under pressure by a roller which is arranged to face the building platform with a specified slip angle with respect to the extending direction of the applied rubber strip and which is heated up to a plasticizing temperature region to smoothen the outer surface of the said tire.

Moreover, a difference between rotational speeds of the building platform and the said pressing roller is preferably within a range of 0-30% of a rotational speed of the building platform.

Furthermore, the slip angle is preferably 30 degrees or less.

Moreover, the pressing roller is preferably heated up to 100-130 degrees Celsius.

In addition, the pressing roller preferably flattens the stepped part of the overlapping portion under pressure with a pressing force of the pressing roller against the building platform being within a range of 200-1000 kPa.

When it is more important to reduce the operation time, the step of spirally winding the rubber strip to apply it on the building platform and the step of flattening by the pressing roller are preferably performed simultaneously with a specified time difference between the steps.

When securely flattening is an important concern, the step of flattening by the pressing roller is preferably performed after finishing the step of spirally winding the rubber strip to apply it on the building platform. In this case, it is more preferable to move the pressing roller in the direction opposed to that in the step of spirally winding the strip.

Moreover, the pressing roller is preferably inclined with respect to the normal line to the tire surface toward its moving direction to have a camber angle.

The tire-manufacturing apparatus according to the invention comprises a building platform such as a rigid core or a building drum; a rubber strip extruder of extruding the ribbon-shaped rubber strip which is displaceable along the outer surface of the building platform and which is spirally winded and applied directly or indirectly on the building platform while making an overlapping portion to form a specified tire component member; a pressing roller of flattening a stepped part of the overlapping portion exposed to the outer surface of the tire component member under pressure, the pressing roller being arranged to face the building platform with a specified slip angle with respect to the extending direction of the applied rubber strip; a heater of heating up the surface of the said roller; and a temperature controller connected to the said heater to keep the roller at a specified temperature.

Moreover, the roller is preferably provided with knurling on the surface.

### BRIEF DESCRIPTION OF THE DRAWINGS

FIG. 1 is a schematic view of one embodiment of a tire-manufacturing apparatus according to the invention;

FIG. 2 is a side view of the tire-manufacturing apparatus shown in FIG. 1;

FIG. 3 is a diagram showing a procedure of forming a tire component member according to the invention;

FIG. 4 is a top view of a pressing roller;

FIG. 5 is a cross sectional view of a tire component member formed according to the invention;

FIG. 6 shows an example of a procedure of flattening a stepped part of an overlapping portion according to the invention;

FIGS. 7(a) and 7(b) are graphical representations showing roughness of an outer surface of a tire component member; and

FIGS. 8(a) and 8(b) show another examples of a procedure of flattening a stepped part of an overlapping portion according to the invention.

### BEST MODE FOR CARRYING OUT THE INVENTION

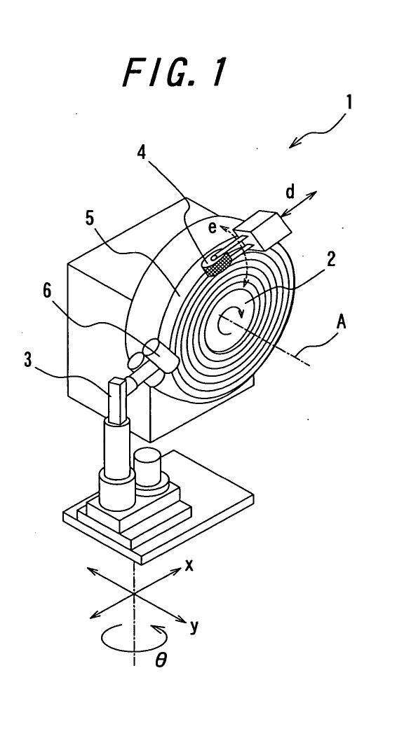

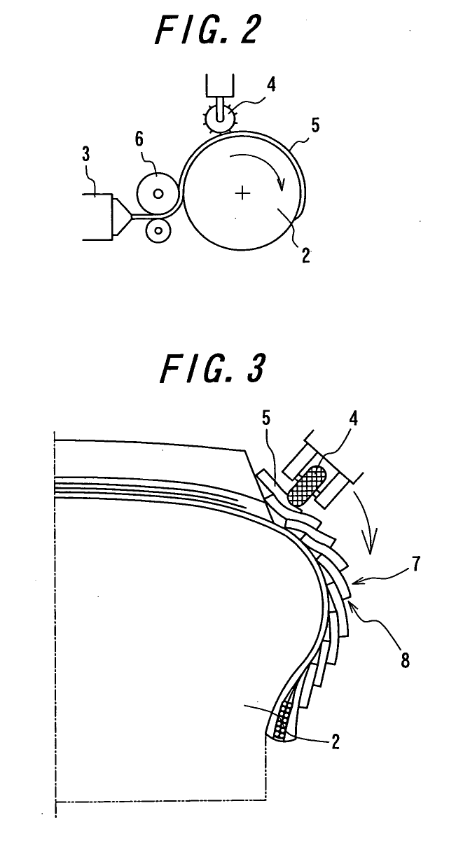

In the following, embodiments of the present invention are described with reference to accompanying drawings. FIG. 1 is a schematic view of an exemplary tire-manufacturing apparatus according to the invention. FIG. 2 is a side view of the tire-manufacturing apparatus shown in FIG. 1.

The tire manufacturing apparatus 1 shown in FIGS. 1 and 2 has a building platform 2 such as a rigid core or a building drum, a rubber strip extruder 3, and a pressing roller 4. The building platform 2 is mounted rotatably around a rotation axis A. Moreover, the rubber strip extruder 3 serves for continuously providing a ribbon-shaped rubber strip 5 having a specified width, for example, through a winder 6 to the building platform 2. The rubber strip extruder 3 and the winder 6 are displaceable in the directions as shown by arrows x, y, and θ in the figure so that they can be constantly kept in a specified position and angle with respect to an applied surface of the building platform 2. In forming a specified tire component member, the rubber strip 5 extruded from the rubber strip extruder 3 is spirally winded and applied on a building platform 2 while rotating the building platform 2 around the rotation axis A, with making an overlapping portion width of which is preferably within a range of 5-90% of that of rubber strip 5. In this state, the rubber strip 5 may be applied directly on the building platform 2, but other component member such as an inner liner may be preliminary applied on the building platform 2, if necessary, and the rubber strip 5 may be indirectly applied to the building platform 2 on the above-mentioned component member.

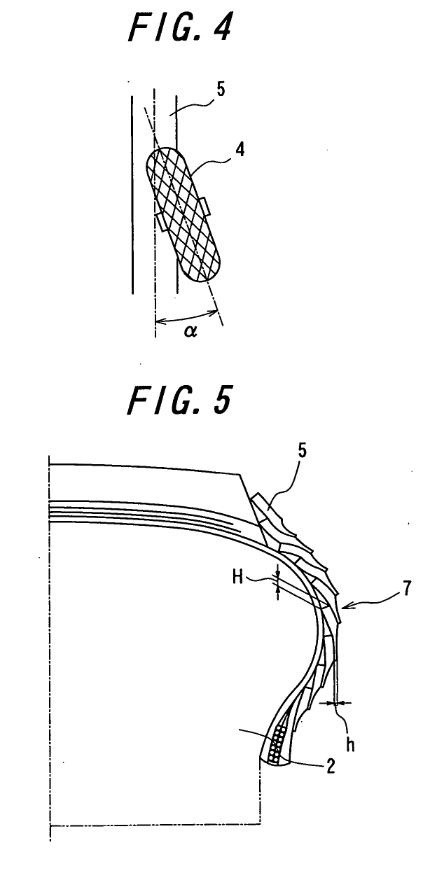

The main constitutional feature of the invention lies in that the stepped part of the overlapping portion 7 exposed to the outer surface of the tire component member is flattened, as shown in FIG. 3, to smoothen the outer surface of the tire by means of the pressing roller 4 which is arranged to face the building platform 2 with a specified slip angle α with respect to the extending direction of the applied rubber strip 5, as shown in FIG. 4, and is heated up to a plasticizing temperature region.

In the following, it will be discussed, along with its operation, how the above-mentioned arrangement is adopted in the invention. As described above, when the rubber strip is applied on the building platform to form the tire component member, the stepped part having the height corresponding to that of the rubber strip occurs at the overlapping portion exposed to the outer surface of the tire component member. FIG. 7(a) is a graphical representation of roughness of the outer surface of the tire component member in such a state. If a stepped part exists in this way, an unevenness of the outer surface increases to prevent close contact between the tire-vulcanizing mold and the tire component member, so that the insufficient molding in the vulcanization is likely to occur and air enclosed between the stepped part of the overlapping portion and a tire-vulcanizing mold is likely to remain in the tire component member as it is incorporated by a rubber flow during the vulcanization. Therefore, the bares and the flow cracks occur from said stepped part and stress concentrates at the air-remaining portion, which may deteriorate the durability of the product tire.

In order to eliminate the stepped part, proposed is a method for smoothening the outer surface of the tire component member in which the stepped part formed at the overlapping portion is flattened by a roller or the like under pressure. However, in the ambient temperature range, the rubber strip deforms dominantly by elastic deformation rather than the plastic deformation, so that, in order to flatten the stepped part under pressure to the extent that the tire-vulcanizing mold and the tire component member can be closely contacted, the pressing force applied to the roller has to be excessive or the pressing time by the roller has to be long. Therefore, it is difficult to improve production efficiency and, moreover, the desired durability cannot be acquired as the shape of the rubber returns back to the original shape due to the elasticity of the rubber after the pressing and before the vulcanization.

The inventor found that when the roller is heated up to the plasticizing temperature where the rubber strip deforms dominantly by plastic deformation rather than the elastic deformation, the rubber strip deforms easily due to the heat upon pressing the stepped part under pressure with relatively small pressing force for relatively short pressing time, so that the outer surface of the tire component member is flattened sufficiently as shown in FIG. 7(b) and the amount of recovery in shape after pressing due to elasticity is reduced, which can prevent the occurrence of the bare and the flow cracks as well as the residual air in the stepped part and therefore improve the durability of the product tire. The present invention has completed in this way.

Moreover, the pressing roller 4 may be rotatably supported by a bearing or the like and the rotational speed of the pressing roller 4 may confirm to that of the building platform 2. Alternatively, the pressing roller 4 may also be rotationally driven and have a difference in rotational speed with respect to that of the building platform 2. The reason is that, if the rubber strip is pressed under these circumstances, the shear stress is produced in a rotational direction of the building platform 2, thereby enhancing the flattening effect. In this case, the difference in rotational speed is preferably 30% or less of the rotational speed of the building platform. When the difference in rotational speed exceeds 30%, the shear stress becomes excessive and can damage the outer surface of the rubber strip 5.

Further, the slip angle α of the pressing roller 4 is preferably 30 degrees or less. By providing the slip angle α to the pressing roller 4, the shear stress is produced in a rotational direction of the building platform 2, thereby enhancing the flattening effect. The reason why the slip angle α of 30 degrees or less is preferable is that, when the slip angle is larger than 30 degrees, the shear stress becomes excessive and can damage the outer surface of the rubber strip 5. In addition, it is more preferable that the strip angle is within a range of 0-10 degrees.

Furthermore, the pressing roller 4 is preferably heated up to 100-130 degrees Celsius. The reason is that, when the temperature of the pressing roller 4 is less than 100 degrees Celsius, the pressing time and/or the pressing force need to be larger for the securely flattening, with the result that the manufacturing efficiency is deteriorated. When the temperature exceeds 130 degrees Celsius, flow of the rubber strip 5 is likely to occur, with the result that a part pressed by the pressing roller 4 may form a recess, the rubber strip may adhere to the pressing roller 4, and the surface of the rubber may get burned.

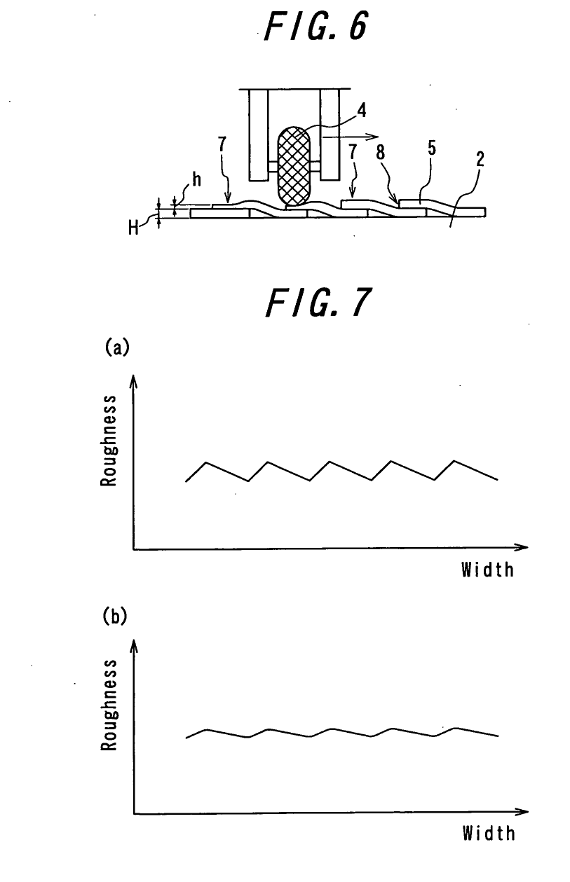

FIG. 5 shows a state of the tire component member shown in FIG. 3 after pressing the overlapping portion 7 under pressure. The pressing roller preferably presses the stepped part 8 of the overlapping portion 7 under pressure with a pressing force of the pressing roller against the building platform being within a range of 200-1000 kPa. The reason is that, when the pressing force is less than 200 kPa, the flattening effect can be insufficient and, when the pressing force is more than 1000 kPa, a part pressed by the pressing roller 4 may form a recess. In addition, the pressing force of the pressing roller 4 is preferably chosen so that the height h of the stepped part 8 of the overlapping portion 7 after flattening as shown in FIG. 6 is within a range of 40-90% of the thickness H of the rubber strip 5.

When it is more important to reduce the operation time, the step of spirally winding the rubber strip 5 to apply it on the building platform 2 and the step of flattening by the pressing roller 4 are preferably performed simultaneously as shown in FIG. 2 with a specified time difference, preferably of a second or less between the steps. In this case, the moving direction of the pressing roller 4 inevitably corresponds to the applying direction of the strip so that a force is produced to separate the rubber strip 5 from the adjacent rubber strip 5 which forms the overlapping portion 7 with the former rubber strip 5. However, the pressing roller 4 has the slip angle and the shear force produced by the slip angle is much lager than said separating force, so that the overlapping portion 7 can be effectively flattened as a whole.

When more stabilized flattening is needed, the step of flattening by the pressing roller 4 is preferably performed after finishing the step of spirally winding the rubber strip to apply it on the building platform as shown in FIGS. 3 and 6. In this way, it is possible to separately perform the step of flattening the stepped part 8 optimizing the rotation and the positioning of the building platform 2 and the pressing roller 4 and, in addition, the pressing roller 4 can be moved in the direction opposed to that of the step of applying the strip. In this case, the stepped part 8 can be efficiently flattened so that said separating force is not produced, thereby further securing the flattening of the overlapping portion 7.

The surface of the pressing roller 4 is kept at specified temperature by means of a heater and a temperature controller. The heater can be embedded in the pressing roller 4 or can be located outside to heat pressing roller 4 by radiant heat. Alternatively, the pressing roller 4 itself can consist of a heating element.

Moreover, the pressing roller 4 is preferably provided with knurling on the surface as shown in FIG. 4. Unevenness on the surface formed by the knurling increases friction between the pressing roller 4 and the rubber strip 5, thereby further securing the flattening of the overlapping portion 7. From the viewpoint of stable flattening, the width of the pressing roller 4 is more preferably within a range of 25-100% of the width of the rubber strip 5. The knurling is more preferably provided on the surface region having a width within a range of 25-100% of the width of the pressing roller 4. The depth of the knurling is more preferably within a range of 5-50% of the width H of the rubber strip 5.

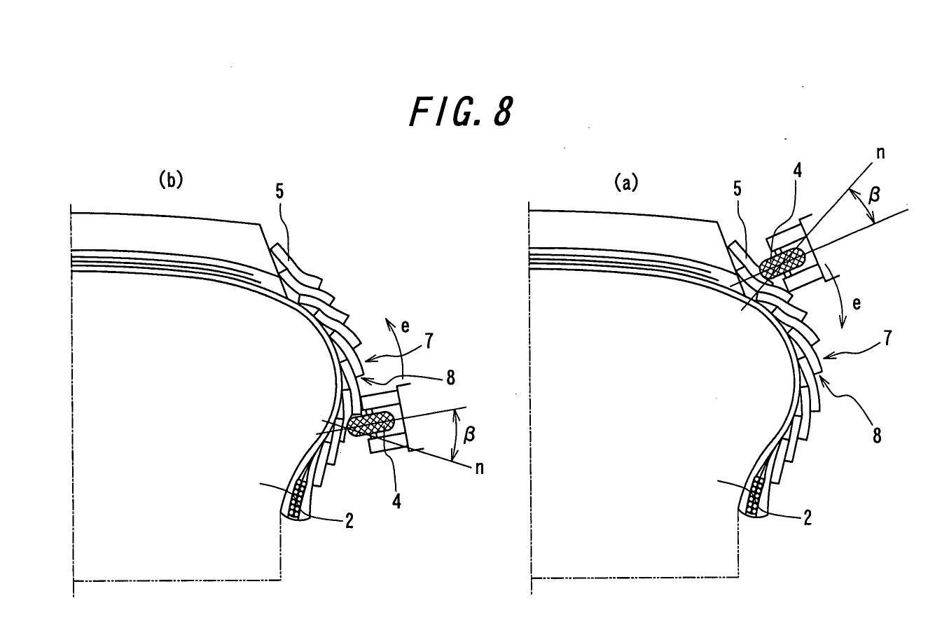

FIG. 8(a) shows a case where the step of flattening is performed by moving the pressing roller 4 from a tread portion toward a bead portion in a direction as shown by the arrow e. FIG. 8(b) shows a case where the step of flattening is performed by moving the pressing roller from the bead portion toward the tread portion in a direction as shown by the arrow e. As shown in these figures, the pressing roller 4 is preferably inclined toward its moving direction e with respect to the normal line to the tire surface to have a camber angle β. By inclining the pressing roller 4 with respect to the normal line to the tire surface in the pressing direction to provide the chamber angle β, effects of expanding, flattening, and pressing can be exerted in the widthwise direction of the rubber strip. From the viewpoint of preventing the rubber strip 5 from falling apart, the chamber angle β is preferably within a range of 15 degrees or less. When the moving speed of the pressing roller 4 is fast, the chamber angle β is more preferably set to be large, and when the moving speed is slow, the chamber angle β is more preferably set to be small. More preferably, the chamber angle β is controlled as a function of the moving speed of the pressing roller.

The descriptions above show only a part of the preferred embodiments of the invention, and various modifications can be made within the scope of the appended claims. For example, FIG. 1 shows an example in which the whole overlapped portion is flattened by one pressing roller. However, each one pressing roller may be provided respectively on the right and left sides of the building platform to simultaneously flatten the overlapped portion of the right and left.

### EXAMPLE

A tire is experimentally manufactured by the method in accordance with the invention and evaluations are made for this tire, which is described in the following.

A Example tire is built by spirally winding a ribbon shaped rubber having a width of 15 mm and a thickness of 1.0 mm while making an overlapping portion of 5 mm to apply it on a building platform and by pressing a stepped part of the overlapping portion under pressure with a pressing roller which is heated up to 110 degrees Celsius. In this process, a difference between rotational speeds of the building platform and the pressing roller is 5% of a rotational speed of the building platform; a slip angle with respect to the extending direction of the applied rubber strip is 2 degrees; a pressing force of the pressing roller is 500 kPa; the step of spirally winding the rubber strip to apply it on the building platform and the step of flattening by the pressing roller are performed simultaneously with a specified time difference between the steps; and the pressing roller have a chamber angle of 5 degrees.

For the purpose of comparison, a tire is built by the same process as the Experiment tire except that the pressing roller is not used (in the case of “Conventional tire”) or a tire has the same configuration as that of the Experiment tire except that the pressing roller is not heated, in which the surface of the pressing roller is 20 degrees (“Comparative tire”).

(Stepped Part)

The height of the stepped part formed at the overlapping portion of each of the above-mentioned test tires is measured immediately after building the green tire and just before the vulcanization of the green tire. The measured values are shown in Table 1.

(Durability)

After measuring the stepped parts, each test tire is vulcanized in a tire-vulcanizing mold, and the tires, tire size of which are 215/45R17, are obtained. Each tire is mounted on a standard rim (7JJ) to assemble a tire wheel. Each wheel is inflated with an air pressure of 200 kPa (relative pressure) and driven on the drum test machine under the condition of running velocity of 210 km/h and a tire load mass of 5 kN. The running distance until a trouble occurs in the tire or it reaches to 10,000 km is measured to evaluate the durability of the tire. The running distances of each test tire are shown in Table 1.

TABLE 1

| | Stepped portion | | |
|---|---|---|---|
| | Immediately | Just before | |
| | after molding | vulcanization | Running Distance |
| Conventional example | 1.0 mm | 1.0 mm | 6,500 km |
| Comparative example | 0.3 mm | 0.8 mm | 8,500 km |
| Example | 0.3 mm | 0.3 mm | 10,000 km |

As shown in Table 1, the conventional tire and the comparative tire are broken down before the running distance reaching 10,000 km. A region where the trouble occurs is visually inspected to find in both tires a crack extending from the stepped part of the outer surface of the sidewall portion toward inside of the tire. In contrast, in the tire of the embodiment, any crack is not found by the visual observation after finishing the running test of 10,000 km. Thus, it is understood that the Experiment tire has superior durability compared with the conventional tire and the comparative tire.

### INDUSTRIAL APPLICABILITY

According to the invention, it becomes possible to provide a tire-manufacturing method which can suppress the residual air and the occurrences of the bares, the flow cracks and the like, which cause the reduction of the durability of the product tire, by flattening the stepped part formed at the overlapping portion of the tire component member under pressure to optimize a cross sectional shape of the overlapping portion, and an apparatus used for this method.

1. A method for manufacturing a tire comprising a step of forming a specified tire component member by spirally winding a ribbon-shaped rubber strip while making an overlapping portion to apply it directly or indirectly on a building platform such as a rigid core or a building drum, wherein a stepped part of the said overlapping portion exposed to the outer surface of the said tire component member is flattened under pressure by a roller which is arranged to face the building platform with a specified slip angle with respect to the extending direction of the said applied rubber strip and which is heated up to a plasticizing temperature region to smoothen the outer surface of the said tire.

2. The method for manufacturing a tire according to claim 1, wherein a difference between rotational speeds of the building platform and the said pressing roller is within a range of 0-30% of a rotational speed of the building platform.

3. The method for manufacturing a tire according to claim 1, wherein the slip angle is 30 degrees or less.

4. The method for manufacturing a tire according to claim 1, wherein the said pressing roller is heated up to 100-130 degrees Celsius.

5. The method for manufacturing a tire according to claim 1, wherein the pressing roller flattens the stepped part of the said overlapping portion under pressure with a pressing force of the pressing roller against the said building platform being within 200-1000 kPa.

6. The method for manufacturing a tire according to claim 1, the step of spirally winding the rubber strip to apply it on the building platform and the step of flattening by the pressing roller are performed simultaneously with a specified time difference between the steps.

7. The method for manufacturing a tire according to claim 1, the step of flattening by the pressing roller is performed after finishing the step of spirally winding the rubber strip to apply it on the building platform.

8. The method for manufacturing a tire according to claims 7, wherein the said pressing roller is moved in the direction opposed to that in the step of spirally winding the strip to press the said stepped part under pressure.

9. The method for manufacturing a tire according to claim 1, the pressing roller is inclined with respect to the normal line to the tire surface toward its moving direction to have a camber angle.

10. An apparatus for manufacturing a tire, comprising a building platform such as a rigid core or a building drum; a rubber strip extruder of extruding the ribbon-shaped rubber strip which is displaceable along the outer surface of the said building platform and which is spirally winded and applied directly or indirectly on the building platform while making an overlapping portion to form a specified tire component member; a pressing roller of flattening a stepped part of the said overlapping portion exposed to the outer surface of the said tire component member under pressure, the pressing roller being arranged to face the building platform with a specified slip angle with respect to the extending direction of the said applied rubber strip; a heater of heating up the surface of said roller; and a temperature controller connected to the said heater to keep the roller at a specified temperature.

11. The apparatus for manufacturing a tire according to claim 10, wherein said roller is provided with knurling on the surface.
